(19) United States
(12) Patent Application Publication
(10) Pub. No.: US 2009/0199877 A1
(43) Pub. Date: Aug. 13, 2009

(54) PROCESS FOR MAKING A WATER-SOLUBLE POUCH

(76) Inventors: Piotr Koch, Wezembeek Oppem (BE); Dirk Boysen, Tervuren (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/365,393

(22) Filed: Feb. 4, 2009

(30) Foreign Application Priority Data
Feb. 8, 2008 (EP) 08101442.5

(51) Int. Cl. B08B 7/00; C11D 17/08; B31B 1/14

(52) U.S. Cl. 134/42; 510/296; 493/223

(57) ABSTRACT

A process for making a detergent water-soluble pouch having a plurality of compartments the process comprising the steps of:
a) making a first web of open or closed pouches in a first pouch making unit having a forming surface;
b) making a second web of open or closed pouches in a second pouch making unit having a forming surface;
c) combining the first and second webs of pouches wherein the forming surfaces bring the web of pouches into contact and preferably exert pressure on them to seal the webs; and
d) cutting the resulting web of pouches to produce individual pouches having a plurality of compartments.

### TECHNICAL FIELD

The present invention is in the field of detergents, in particular in the field of water-soluble multi-compartment detergent pouches. It relates to a process for making multi-compartment pouches. The process is very versatile and suitable for making multi-compartment pouches of complex geometry. The invention also relates to multi-compartment pouches and their use in laundry and automatic dishwashing machines.

### BACKGROUND OF THE INVENTION

It is a challenge to make detergent multi-compartment pouches, in particular pouches having size restrictions, more than two compartments and compositions in different physical forms. It is even more difficult to make multi-compartment pouches with compartments having different footprints and complex geometries.

Processes for making multi-compartment water-soluble pouches are known in the art. For example, WO 02/085736 describes a process for making a water-soluble pouch having two compartments joined by a folding portion, the folding portion is folded and the compartments adhere to one another. EP 1 375 637 A1 describes a thermoforming process for making a multi-compartment pouch using a forming dye having at least two different cavities. WO 02/092456 describes an injection moulding process for making a multi-compartment pouch. EP 1 504 994 B1 also relates to a process for making multi-compartment water-soluble pouches.

Existing pouch-making processes may require either: i) to form a multi-compartment pouch in a single mould with more than one cavity-as it is the case in '736, '637 and '456; or ii) to form an open web of pouches and close it with a pre-formed web-as it is the case in '994. The first type of processes, in particular those of '637 and '456, does not seem adequate to make pouches having compartments in superposed configuration, the compartments are usually in a side-by-side arrangement. The pouches made according this type of processes can be found to be difficult to fit in spaces of defined dimensions as for example the dispenser of an automatic dishwashing machine. The process of '736 requires two middle films and to adhere the middle films to each other in order to make a pouch with superposed compartments, this requires the use of an extra film and adhesive thereby increasing the cost of the product, process complexity and probably impairing on the dissolution of the pouch.

The process of '994 may involve the additional step of superposing and aligning the preformed web onto the open web. This in practice tends to be very difficult.

The objective of the present invention is to provide a process for making multi-compartment pouches wherein the compartments, at least some of them, have complex geometries. In particular, a process for making multi-compartment pouches having compartments in a superposed and side-by-side configuration.

### SUMMARY OF THE INVENTION

According to a first aspect of the present invention, there is provided a process for making a detergent water-soluble pouch having a plurality of compartments (i.e., a multi-compartment pouch). The pouch has at least two-compartments, preferably at least three compartments. Preferably the pouch has compartments in a superposed configuration and compartments in a side-by-side configuration. Preferably, the process comprises the steps of:
a) making a first web of open or closed pouches in a first pouch making unit having a forming surface; the first web is made by placing a water-soluble film on the surface of the pouch making unit, the surface has moulds into which a water-soluble film is drawn to form open compartments; the compartments are filled with a detergent composition or part thereof, the resulting open pouches are optionally closed by means of closing means;
b) making a second web of open or closed pouches in a second pouch making unit having a forming surface; the second open pouches are made in a similar manner to the first and preferably they are subsequently closed;
c) combining the first and second webs of pouches wherein the first and second forming surfaces bring the web of pouches into contact and preferably exert pressure on them to seal the webs; and
d) cutting the resulting web of pouches to produce individual pouches having a plurality of compartments.

By “detergent pouch” is meant a detergent product in unit dose form in which a detergent composition is enveloped by water-soluble film. The pouches of the invention have more than one, preferably more than two compartments, more preferably at least three compartments. By “compartment” herein is meant a portion of the unit dose product in which part of the detergent composition is enveloped by water-soluble film. By “open pouch” is herein meant a piece of film holding a detergent composition, or part thereof, that will be later closed with a film or preformed compartment thereby forming a compartment of a multi-compartment pouch.

The process of the invention involves the combination of two webs of pouches, directly from the forming surfaces, to form a web of multi-compartment pouches without requiring the intermediate step of removing one or two of the webs from the corresponding forming surface before combining it with the other web. Preferably, the first and second webs stay on the forming surface until the two webs have been combined. The second web is shortly released from the second surface after the two webs have been combined. This obviates the need of alignment of the two webs that in practice, has been found to be very difficult, probably due to the elastic nature of the water-soluble film. Misalignment can give rise to pouches with leakages and pouches that do not comply with the manufacturing requirements and need to be rejected. The problem of misalignment does not occur in the process of the invention. Another advantage of the process of the invention is its flexibility in terms of the shape, geometry and configuration of the compartments. It is particularly advantageous to produce water-soluble multi-compartment pouches having compartments in a superposed relationship and compartments in a side-by-side relationship.

The process of the invention permits to minimise the amount of film used in the multi-compartment pouches. For example, three compartments can be made by using only three pieces of film. At the same time the pouches can have controlled and/or differential dissolution by having pieces of film with different dissolution profiles. In addition the process of the invention allows the use of very thin films because the pouches are not released from the moulds until they are fully formed and it is not necessary to relay on the robustness of the film to confer strength to the pouch.

Preferably, the pouches of the first web are open pouches, before they are closed by the second web of pouches, this avoids the need to use an extra film between the first and the second compartment, avoiding an extra sealing step, reducing costs, process complexity and at the same time giving rise to stronger pouches, extra sealing steps can give rise to weaker pouches, sealing zones can be prone to weakness, leakages and ruptures. Alternatively, the first web of pouches can be a web of closed pouches.

In preferred embodiments, at least the forming surface of one pouch making unit and more preferably the forming surface of the second pouch making unit is coated with an elastic material, preferably rubber or silicone. This significantly helps with the web combining.

In preferred embodiments, the web of pouches are held onto the making surfaces by vacuum, preferably vacuum is applied to the webs and it is maintained until after the two webs have been combined. This greatly helps the alignment of the two webs.

In preferred embodiments the forming surface of the first pouch making unit is a horizontal unit. It is also preferred that the forming surface of the second pouch making unit is circular. More preferably, the second pouch making unit is a rotatory drum. Pouches are filled at the top of the drum and preferably sealed afterwards with a layer of film, the closed pouches come down to meet the first web of pouches, preferably open pouches, formed in the horizontal forming surface. It has been found especially suitable to place the second pouch forming unit above the first pouch forming unit in particular when the second pouch forming unit is a rotatory drum.

Specially preferred are embodiments in which the first pouch making unit is a horizontal unit and the second pouch making unit is a rotatory drum -coated with an elastic material- placed above the first pouch making unit.

The present invention also envisages embodiments in which the two pouch making units are rotatory drums. In these embodiments, it is preferred that the two drums are placed either one above the other or side-by-side (1800 from one another) and they bring the two webs together in the middle point of the drums.

In an especially preferred embodiment, the process for making the detergent water-soluble multi-compartment pouch comprises the steps of:
a) making a first web of powder-containing open pouches in a first pouch making unit having a forming surface;
b) making a second web of liquid-containing side-by-side closed pouches in a second pouch making unit having a forming surface, preferably coated with an elastic material;
c) combining the first and second webs of pouches by superposing the second web of closed pouches onto the first web of open pouches wherein the forming surfaces bring the webs of pouches into contact and exert pressure on them to seal the webs and form a web of multi-compartment pouches; and
d) cutting the resulting web of pouches to produce individual pouches having two-side by side liquid compartments superposed onto a powder compartment.

Preferably the powder is a densified powder. It is also preferred to wet the second web of pouches before bringing into contact with the second web.

According to another aspect of the invention, there is provided a detergent water-soluble pouch obtainable, preferably obtained, according to the process of the invention. The pouches can be very compact, which is particularly suitable for applications with volume limitations, such as automatic dishwashing, wherein the dispenser for the detergent is of a fix geometry and size.

In a preferred embodiment the multi-compartment pouch obtainable according to the process of the invention has two side-by-side compartments superposed onto another compartment. Multi-compartment pouches with compartments in superposed configurations are not only preferred from a dispenser fit standpoint but also from a product stability viewpoint. It is believed that compartments placed one above the other may help to protect each other from the surrounding environment, in particular in humid environments.

Preferably the side-by-side compartments contain liquid compositions and the other compartment preferably contains a powder composition, more preferably a densified powder. This embodiment gives a great formulation flexibility, it allows to have in the same unit dose product compositions or parts thereof in different physical forms, i.e., solid and liquid and at the same time incompatible compositions in the same physical form, i.e., two different liquids.

According to the last aspect of the invention, there is provided a method of laundry or dishwashing in an automatic machine using the multi-compartment pouch of the invention. Preferably, in the case of a dishwashing method, the multi-compartment pouch is placed into the product dispenser of an automatic dishwashing machine from where it is released into the dishwasher. As stated before the pouch of the invention can be particularly suitable for this type of executions, because it is very compact.

### DETAILED DESCRIPTION OF THE INVENTION

The present invention envisages a process for making multi-compartment water-soluble pouches. The process is suitable for making pouches having compartments with different footprints and complex geometries and containing compositions or parts thereof in different physical forms. The process is fast and very versatile, furthermore, it allows for an efficient use of the water-soluble film. The present invention also envisages multi-compartment water-soluble pouches obtainable, preferably obtained, according to the process of the invention. The pouches are robust and compact and allow for the separation of components in different physical forms and incompatible ingredients.

The process of the invention is suitable for making pouches having any number of compartments, it is especially suitable for making pouches with at least two side-by-side compartments, although the number of side-by-side compartments is not limited to two.

Pouch making units suitable for use herein, as first and/or second pouch making unit, have a forming surface with moulds, the moulds can have one or more than one cavities. A water-soluble film is fed onto the forming surface and draw into the moulds, preferably by vacuum means. The film can be heated before being drawn into the moulds and then drawn by vacuum means (this process either with or without heating of the film is referred herein as vacuum-forming) to form a recess or plurality of recesses. Alternatively, the film can be drawn down into the moulds preferably with the help of vacuum or blown down under pressure into the mould and heated to the thermoforming temperature to mould the film onto the moulds (this process either with or without vacuum or pressure is referred herein as thermo-forming) to form a recess or plurality of recesses. Once the recess(es) is/are formed, they are filled with a detergent composition or part thereof to form open pouches. Subsequently the pouches are closed by for example placing a film or a preformed pouch on top of the filled recess and sealing the films together. Thereafter, the pouches are cut to form individual multi-compartment pouches. Preferably, pouches of the first web are open pouches before they are closed by the second web. Preferably, the pouches of the second web are closed with a film, once the open pouches are formed, a film is wetted on its underside and sealed onto the web of open pouches. The top film of the pouches of the second web is wetted on its upper side and brought into contact with the first web of open pouches to seal those open pouches and thereby give rise to a web of multi-compartment pouches.

A process for making thermo-formed pouches is described in WO 00/55045. Thermoforming is a well-known technique for preparing articles from a polymer. It generally comprises heating a polymeric composition, which can be in the form of, for example, a film, to above its softening temperature and thermally deforming the composition in a mould.

The web of pouches can be made by injection moulding as described in WO 02/092456.

Preferably the pouch making units, or at least one of them, have a moving surface. Preferably, the first pouch making unit has a horizontal moving forming surface and the second pouch making unit has a circular moving (i.e., rotating) forming surface.

A preferred pouch making unit for use herein, in particular as second pouch making unit, is a rotatory drum, as described in U.S. Pat. No. 3,057,127.

Preferably, the first web of pouches is made in a horizontal, preferably moving, forming surface and the second web of pouches is made in a circular, preferably rotating, forming surface. Preferably, the second forming surface is placed above the first forming surface, the configuration being such that the lowest point of the second surface exerts a pressure on the web of pouches formed on the first forming surface.

The process used herein for forming the first and/or second webs involves feeding, preferably in a continuous manner, a water-soluble film onto a forming surface. Preferably the surface is a moving surface and more preferably an endless surface. Naturally, different film material and/or films of different thickness may be employed in making and/or closing the first and second moving webs, where for instance compartments having different solubility or release characteristics are required.

In a preferred embodiment for making the first web of pouches a portion of an endless surface will move continuously in horizontal rectilinear motion, until it rotates around an axis perpendicular to the direction of motion, typically about 180°, and then move in the opposite direction, usually again in horizontal rectilinear motion. Eventually, the surface will rotate again to reach its initial position. In other embodiments, the forming surface, in particular the second surface, moves in curvilinear, for example circular motion.

The term ‘endless surface’ as used herein, means that the surface is endless in one dimension at least, preferably only in one dimension. For example, the surface is preferably part of a rotating platen conveyer belt comprising moulds, as described below in more detail.

The forming surface can have any width, typically depending on the number of rows of moulds across the width, the size of the moulds and the size of the spacing between moulds. Where designed to operate in horizontal rectilinear manner the horizontal portion of the endless surface can have any length, typically depending on the number of process steps required to take place on this portion of the surface (during the continuous horizontal motion of the surface), on the time required per step and on the optimum speed of the surface needed for these steps. Of course, by using a lower or higher continuous speed throughout the process, the length of the surface may need to be shorter or longer. For example, if several steps are performed on the horizontal portion, the portion needs to be longer or the speed slower than if for example only two steps are done on the horizontal portion.

Preferred may be that the width of the horizontal surface is up to 1.5 meters, or even up to 1.0 meters or preferably between 30 and 60 cm. Preferred may be that the horizontal portion of the endless surface is from 2 to 20 meters, or even 4 to 12 meters or even from 6 to 10 or even 9 meters.

The diameter of the circular surface is determined by the size of the pouches.

The surfaces are typically moved with a constant speed throughout the process, which can be any constant speed. Preferred may be speeds of between 1 and 80 m/min, or even 10 to 60 m/min or even from 2- to 50 m/min or even 30 to 40 m/min.

Web formation, in particular the formation of the first web of pouches, is preferably done on an endless surface which has a horizontal motion for such a time to allow formation of the web of cavities, filling of the pouches, superposition of the second moving web of pouches, sealing of the two moving webs and cutting to separate the superposed webs into a plurality of multi-compartmental pouches. Then, pouches are removed from the surface and the surface will rotate around an axis perpendicular to the direction of motion, typically about 180 degrees, to then move in opposite direction, typically also horizontally, to then rotate again, where after step a) starts again.

Preferably, the surface is part of and/or preferably removably connected to a moving, rotating belt -for example a conveyer belt or platen conveyer belt- or rotating drum. Then preferably, the surface can be removed and replaced with another surface having other dimensions or comprising moulds of a different shape or dimension. This allows the equipment to be cleaned easily and moreover to be used for the production of different types of pouches. This may for example be a belt or drum having a series of platens, whereof the number and size will depend on the length of the horizontal portion and diameter of turning cycles of the surface, for example having 50 to 150 or even 60 to 120 or even 70 to 100 platens, for example each having a length (direction of motion of platen and surface) of 5 to 150 cm, preferably 10 to 100 cm or even 20 to 45 cm.

The platens then form together the forming surface or part thereof and typically the moulds are comprised on the surface of the platens, for example each platen may have a number of moulds, for example up to 20 moulds in the direction of the width, or even from 2 to 10 or even 3 to 8, and for example up to 15 or even 1 to 10 or even 2 to 6 or even 2 to 5 moulds lengthwise, i.e. in the direction of motion of the patens.

The forming surface, or typically the belt connected to the surface, can be continuously moved by use of any known method. Preferred is the use of a zero-elongation chain system, which drives the surface or the belt connected to the surface.

If a platen conveyer belt is used, this preferably contains a) a main belt (preferably of steel) and b) series of platens, which comprise 1) a surface with moulds, such that the platens form the endless surface with moulds described above, and 2) a vacuum chute connection and 3) preferably a base plate between the platens and the vacuum chute connection. Then, the platens are preferably mounted onto the main belt such that there is no air leakage from junctions between platens. The platen conveyer belt as a whole moves then preferably along (over; under) a static vacuum system (vacuum chamber).

Preferred may be that the forming surface is connected to 2 or more different vacuum systems, which each provide a different under pressure and/or provide such an under pressure in shorter or longer time-span or for a shorter or longer duration. For example, it may be preferred that a first vacuum system provides a under-pressure continuously on the area between or along the moulds/edges and another system only provides a vacuum for a certain amount of time, to draw the film into the moulds. For example, the vacuum drawing the film into the mould can be applied only for 0.2 to 5 seconds, or even 0.3 to 3 or even 2 seconds, or even 0.5 to 1.5 seconds, once the film is on the forming portion of the surface. This vacuum may preferably be such that it provides an under-pressure of between −100 mbar to −1000 mbar, or even from −200 mbar to −600 mbar.

Preferred may be for example that the two or more vacuum systems, or preferably pumps are connected to the chutes described above, such that each vacuum system is connected to each chute, preferably such that the systems are not interconnected with in the chute, to thus completely separate the vacuums from one another and to guarantee controlled delivery of vacuum to the moulds/surface between/along mould/edges.

It should be understood that thus all platens and the main belt move continuously, typically with the same constant speed.

The surface, or platens described above, are preferably made from corrosion resistant material, which is durable and easy to clean. Preferred may be that the surface or platens, including the mould areas are made of aluminium, preferably mixed with nickel, or optionally only the outside layers comprising nickel and/or nickel aluminium mixtures.

Preferably, at least the top layer between and/or in the moulds of the surface is of deformable—preferably elastic-material, preferably at least the top layer between the moulds. The material is typically such that it has a friction coefficient of 0.1 or more, preferably 0.3 or more. For example, the top layer between the moulds, but even in the moulds, can be of rubber, silicon material or cork, preferably rubber or silicon rubber. Preferred is also that the material is not too hard, for example similar to silicon rubber having a shore value of 10 to 90.

The moulds can have any shape, length, width and depth, depending on the required dimensions of the pouches. Per surface, the moulds can also vary of size and shape from one to another, if desirable. For example, it may be preferred that the volume of the final pouches is between 5 and 300 ml, or even 10 and 150 ml or even 20 and 100 ml or even up to 80 ml and that the mould sizes are adjusted accordingly. Preferably the moulds on the first forming surface (first mould) have a volume of from about 5 to about 40 ml, more preferably, from about 10 to about 20 ml and even more preferably from about 14 to about 18 ml. Preferably, the moulds of the second forming surface (second mould) have two cavities, more preferably each of the cavities have a volume of from about 0.1 to about 10, more preferably from about 0.5 to about 2 ml. In especially preferred embodiments, the first mould has a volume of from about 10 to 20 ml and the second mould is a dual cavity mould, each individual mould having a volume of from about 0.5 to about 2 ml. Especially preferred are pouches having a first compartment having a volume of from about 10 to 20 ml and side-by-side compartments superposed onto the first compartment, each of the side-by-side compartments having a volume of form about 0.5 to about 2 ml. Pouches of these dimensions have been found optimum to maximise the amount of actives and at the same time being able to fit in an automatic dishwashing machine dispenser.

The feeding of the film to, and typically onto the forming surface is done continuously, typically with a constant speed throughout the process. This can be done by any known method, preferably by use of rollers from which the film unwinds. The film can be transported from the rollers to the surface by any means, for example guided by a belt, preferably a deformable resilient belt, for example a belt of rubber or silicone material, including silicone rubber. The material is typically such that it has a friction coefficient of 0.1 or more, preferably 0.3 or more.

Preferred may be that the rollers rewind the film with a speed of at least 100 m/min, or even 120 to 700 m/min, or even 150 to 500 m/min, or even 250 to 400 m/min.

Once on the forming surface, the film can be held in position, e.g. fixed or fixated on the surface, by any means. For example, the film can be held with grips or clips on the edges of the surface, where there are no moulds, or pressed down with rollers on the edges of the surface, where there are no moulds, or held down by a belt on the edges of the surface, where there are no moulds.

For ease of operating and film positioning, for improved accuracy and better alignment reliability, and as to not loose too much of the film surface (i.e. positioned in or under the grips, clips rollers or belt), and moreover as to reduce the tension on the film or ensure more homogeneous tension on the film, it is preferred that the film is held in position by application of vacuum on the film, thus drawing or pulling the film in fixed position on the surface. Typically this is done by applying a vacuum (or under-pressure) through the surface which is to hold the film, e.g under the film. Also, this method is suitable even if the film width is larger than the surface, so this system is more flexible than the use of grips or clips.

Preferably, the vacuum is applied along the edges of the film and thus typically the edges of the surface, and/ or on the surface area between or around the moulds, typically along the edges of the moulds. Preferred is that the vacuum is (at least) applied along the edges of the surface.

Preferably, said surface thereto comprises holes which are connected to a device which can provide a vacuum, as known in the art, or so-called vacuum chamber(s). Thus, the surface has preferably holes along the edges of the surface and/ or holes around or between the moulds.

Preferred is that the holes are small, preferably of a diameter of 0.1 mm to 20 mm, or even 0.2 to 10 mm or even 0.5 to 7 or even 1 to 5 mm.

Preferably, at least some of the holes are close to the mould edges, to reduce wrinkling in the area around the mould edges, which in a preferred embodiment herein serves as closing or sealing area; preferably the distance between the edge of the mould and the edge of the first or closest hole is 0.25 to 20 mm form the edge of the mould, or even preferably 0.5 to 5 mm or even 1 to 2 mm.

Preferred is that rows of holes are present along the edge of the surface and/or along the edges of the moulds; preferred may be that 2 or 3 or more rows of holes are present.

The use of many small holes in the manner described above ensures more homogeneous tension of the film, and it reduces the tension needed to fixate the film, and it improves the fixation and it reduces the chance of wrinkling of the film.

The use of a vacuum to fix the film in position is in particular beneficial when the film is subsequently drawn into the moulds by application of a vacuum as well, as described herein after.

The open pouches can be formed in the moulds by any method, and as described above, preferred methods include the use of (at least) a vacuum or under-pressure to draw the film into the moulds. Preferred methods (also) include heating and/or wetting the film and thereby making the film more flexible or even stretched, so that it adopts the shape of the mould; preferably, combined with applying a vacuum onto the film, which pulls the film into the moulds, or combinations of all these methods.

Preferred is that at least vacuum is used herein. In the case of pouches comprising powders it is advantageous to pin prick the film for a number of reasons: firstly, to reduce the possibility of film defects during the pouch formation, for example film defects giving rise to rupture of the film can be generated if the stretching of the film is too fast, secondly to permit the release of any gases derived from the product enclosed in the pouch, as for example oxygen formation in the case of powders containing bleach, and thirdly, to allow the continuous release of perfume. When also heat and/or wetting is used, this can be used before, during or after the use of the vacuum, preferably during or before application of the vacuum.

Preferred is thus that each mould comprises one or more holes which are connected to a system which can provide a vacuum through these holes, onto the film above the holes, as described herein in more detail. Preferred is that the vacuum system is a vacuum chamber comprises at least two different units, each separated in different compartments, as described herein.

Heat can be applied by any means, for example directly, by passing the film under a heating element or through hot air, prior to feeding it onto the surface or once on the surface, or indirectly, for example by heating the surface or applying a hot item onto the film, for example to temperatures of 50 to 120° C., or even 60 to 90° C., preferably for example with infra red light.

The film can be wetted by any mean, for example directly by spraying a wetting agent (including water, solutions of the film material or plasticisers for the film material) onto the film, prior to feeding it onto the surface or once on the surface, or indirectly by wetting the surface or by applying a wet item onto the film.

The filling of the first and second webs of open pouches can be done by any known method for filling (moving) items. The exact most preferred method depends on the product form and speed of filling required.

One method is for example flood dosing, whereby the web of open pouches passes under a dosing unit which is static and which has a device to accurately dose a set amount or volume of product per time unit. The problem or disadvantage of this method may be that product will be dispensed on the areas between the open pouches, which typically serves as sealing area; this not only may be a waste of product, but also makes sealing more difficult. This problem is particulate acute in the case of products in the form of mobile liquids. Paste or gel-form products are more amenable to this kind of filling process.

Generally, preferred methods include continuous motion in line filling, which uses a dispensing unit positioned above the open pouches which has a endless, rotating surface with nozzles, which typically moves rotatably with continuous motion, whereby the nozzles move with the same speed as the pouches and in the same direction, such that each open pouch is under the same nozzle or nozzles for the duration of the dispensing step. After the filling step, the nozzles rotate and return to the original position, to start another dispensing/filling step. Every nozzle or a number of nozzles together, is preferably connected to a device which can accurately control that only a set amount or volume of product is dispensed during one rotation per nozzle, e.g. thus in one pouch.

Preferred may be that the filling/dispensing system is such that from 10 to 100 cycles (filling steps) can be done per minute, or even 30 to 80 or even 40 to 70 per minute. This will of course be adjusted depending o the size of the open pouches, speed of the surface etc.

A highly preferred method for filling the open pouches is a reciprocating-motion-filling method. This process preferably uses a moving filling station which is returnable (changes direction of motion) and variable in speed. The filling station has typically a series of nozzles which each move with the same speed as the open pouches (to be filled) and in the same direction for the period that product needs to dispensed into the open pouches. Then, typically when a pouch is full, the nozzle or nozzles which filled the pouch stop their movement along with the pouch and return in opposite direction, to then stop again, such that it is positioned above another open pouch(es) which is (are) still to be filled, and to then start moving again in opposite direction, with the same speed and direction as the open pouches, until it reaches the speed of the pouches, to then continue with this speed and start dispensing and filling of the pouch(es), as in the previous filling cycle. The speed of the returning movement may be higher than the speed of the movement during filling.

Every nozzle or a number of nozzles together is preferably connected to a device which can accurately control that only a set amount or volume of product is dispensed during one rotation per nozzle, e.g. thus in one pouch.

The filling units or stations used in the process of the invention preferably use a flow meter and/or positive displacement pump to dose the correct amounts or volumes of product per open pouch, in particular a positive displacement pump has been found to very accurate. Hereby, the required amount or volume of product is introduced in the pump and this is then fed to the nozzles. For example, if the system is such that 60 pouches are to be filled per filling cycle, typically 60 nozzles are provided, connected to 60 positive displacement pumps (one pump per nozzle, per pouch), which are all connected to a general tank with product.

The pumps can be adjusted depending on the product to be dispensed. For example, if the product is a viscous liquid, the pumps need to be stronger, if a fast filling, and thus movement of the surface is required.

Other methods which can be used include flow measurement, by use of a magnetic flow meter or mass flow meter, and pressure flow filling/measurement (which keeps the pressure constant and controlling filling time and thereby volume).

It can also be preferred to use a filling system whereby, prior to filling, a second surface with openings, which each has a surface area equal or less than the surface area of an open pouch, is placed above the web of open pouches such that each opening remains positioned above one open pouch during the filling step and that the space between at least part of the moulds is covered by said surface.

The filling will then take place through the openings on this surface or belt, such that the product can only enter in the open pouches and not on the area between the pouches which is covered. This is advantageous because the area between the open pouches (between the moulds), which typically serves as sealing area when closing the pouches, remains free of product, which ensures a better or easier seal.

The filled, open pouches are then closed, which can be done by any method. Preferred in the case of the second moving web is that the closing is done by feeding a second material or film, preferably water-soluble film, over and onto the web of open pouches and then preferably sealing the first film and second film together, typically in the area between the moulds and thus between the pouches. Preferred is that the closing material is fed onto the open pouches with the same speed and moving in the same direction as the open pouches.

Preferred in the case of the first web is that the closing material is the second web of closed, filled pouches, closing being accomplished by the first and second surfaces bringing the two web together, preferably in a continuous manner, more preferably with constant speed and moving in the same direction of the open pouches, and which is subsequently sealed to the first film. Alternatively, the first web can also be closed using a film, as described above for the second web, prior to superposing and sealing the first and second webs of pouches.

The sealing can be done by any method. Preferred methods include heat sealing, solvent welding, and solvent or wet sealing. Hereby it may be preferred that only the area which is to form the seal, is treated with heat or solvent. The heat or solvent can be applied by any method, preferably on the closing material, preferably only on the areas which are to form the seal.

Preferred may be that when heat sealing is used, a roller with cavities of the size of the part of the pouch, which is not enclosed by the mould, and having a pattern of the pouches, is (continuously) rolled over the web pouches, passing under the roller. Hereby, the heated roller contact only the area which is to be the sealing areas, namely between the pouches, around the edges of the moulds. Typically sealing temperatures are from 50 to 300° C., or even from 80 to up to 200° C., depending on the film material of course. Also useful is a movable, returnable sealing device, operating as the returnable, movable filling/dosing device above, which contacts the area between the moulds, around the edges, for a certain time, to form the seal, and then moves away from the sealing area, to return backwards, to start another sealing cycle. In the case of heat sealing, it is important that the sealing area of the second web to the first web does not overlap the sealing area of the individual first and/or second webs of pouches.

If solvent or wet sealing or welding is used, it may be preferred that also heat is applied. Preferred wet or solvent sealing/welding methods include applying selectively solvent onto the area between the moulds, or on the closing material, by for example, spraying or printing this onto these areas, and then applying pressure onto these areas, to form the seal. Sealing rolls and belts as described above (optionally also providing heat) can be used, for example.

The superposed and sealed webs of pouches can then be cut by a cutting device, which cuts the pouches from one another. The cutting can be done by any known method. It may be preferred that the cutting is also done in continuous manner, and preferably with constant speed and preferably while in horizontal position. However, the cutting step does not need to be done in horizontal position, nor continuously. For example the web of closed (sealed) pouches can be transported to the cutting device, e.g. to another surface, where the cutting device operates. Although, for ease of processing it may be preferred to perform the cutting step on the same surface as the previous steps.

The cutting device can for example be a sharp item or a hot item, whereby in the latter case, the that ‘burns’ through the film/sealing area. Preferred may be a roller with sharp tools, such as a knife, with cavities of the size and pattern of the pouches, which rolls over the pouches such that the sharp tools only touch the area to be cut. Preferred may also be when the web of pouches is moving in one direction (e.g. continuously and/or horizontally, for example still on the endless surface herein) a static device contacting the area between the pouches along the direction of movement can be used, to cut the pouches in the direction of movement in a continuous manner. Then, the cutting between the pouches along the direction of the width of the web of pouches can be done by an intermittent cutting step, for example by applying a cutting device for a brief period onto the area, removing the cutting device and repeating this action with the next set of pouches.

The pouch, when used herein can be of any form, shape and material which is suitable to hold the product prior to use, e.g. without allowing the release of the compositions from the pouch prior to contact of the pouched composition to water. The exact execution will depend on for example the type and amount of the compositions in the pouch, the characteristics required from the pouch to hold, protect and deliver or release the compositions, the number of compartments in the pouch.

Preferred herein are water-soluble pouches having two side-by-side compartments comprising liquid compositions and another compartment comprising a powder or densified powder composition. During the manufacture of the liquid compartments an air bubble is typically formed. This air bubble can reduce the compressibility of the pouch and therefore the ease of closing the automatic dishwashing dispenser after placing the pouch therein. It has been found that ease of closing is increased when the ratio of the air bubble diameter to the maximum lateral dimension of the pouch footprint is from about 1:5 to about 1:2. The bubble dimension can be controlled by process parameters.

In use, the water-soluble pouch is usually placed within the washing machine dispenser and released during the main cycle of the dishwashing process. However, the dispensers of some dishwashing machines are not completely water tight, mainly for two reasons, either the dispenser has some apertures allowing water ingress or the dispenser is sealed with a rubber band that can deform with time due to the high temperature of the dishwashing process. Water ingress into the dispenser can cause premature leaking of some of the pouch content which is thus lost at the end of the pre-wash. This problem is especially acute in the case of pouches comprising liquid compositions having a low viscosity wherein a considerable amount of the product can be lost before the main-wash cycle. The problem can be overcome by making the pouch or at least the liquid compartment thereof out of a film material which is designated to survive the pre-wash and to release the pouch contents at or after the start of the main-wash cycle. In European machines, the pre-wash is usually a cold water cycle (about 20° C. or less) without detergent and lasting for about 10 to 15 min.

Preferably the film material has a water solubility according to the hereinbelow defined test of less than about 50%, more preferably less than about 20% and especially less than about 5% under cold water conditions (20° C. or below) when exposed to the water for at least 10 minutes, preferably at least 15 minutes; and a water solubility of at least about 50%, more preferably at least about 75% and especially at least about 95% under warm water conditions (30° C. or above, preferably 40° C. or above) when exposed to the water for about 5 minutes and preferably when exposed to the water for about 3 minutes. Such film materials are herein referred to as being substantially insoluble in cold water but soluble in warm water. Sometimes this is abbreviated simply to “warm water soluble”.

50 grams±0.1 gram of pouch material is added in a pre-weighed 400 ml beaker and 245 ml±1 ml of distilled water is added. This is kept at the desired temperature, by using a water bath, and stirred vigorously on a magnetic stirrer set at 600 rpm, for the desired time. Then, the mixture is filtered through a folded qualitative sintered-glass filter with a maximum pore size of 20 μm. The water is dried off from the collected filtrate by any conventional method, and the weight of the remaining material is determined (which is the dissolved or dispersed fraction). Then, the % solubility or dispersability can be calculated.

Commercially available films insoluble in cold water and soluble in hot water include BP26 available from Aicello, L10 and L15 available from Aquafilm, VF-M and VM-S available from Kuraray and E-2060 available from Monosol.

Pouch compartments containing solid compositions, in particular oxygen bleach comprising compositions, are usually pin-pricked in order to allow the leakage of any formed oxygen. The holes formed by pin pricking also allow the leakage of perfumes or malodors, however. For example, surfactants often have an unpleasant smell associated with them and when such pouches are packed within a secondary package, the unpleasant surfactant smell can be concentrated into the package head space and released each time that the user open the package. This problem can be avoided by including the surfactant in the liquid composition, since liquid containing compartments must be made free of pin holes. Thus, according to another embodiment, the liquid composition comprises a surfactant. Another advantage of having the surfactant in the liquid phase is to avoid problems of loading the surfactant onto the solid material. A further advantage is that the surfactant is released with a certain delay with respect to the solid composition, this allows better performance of the bleach and enzymes which can be adversely affected by interaction between the surfactant and the table/dishware surfaces.

Preferably perfume is introduced in the solid composition, pin prickling allowing for slow release of the perfume before the product is used in the dishwasher.

Films substantially insoluble in cold water and soluble in warm water have relatively low moisture and plasticiser content, therefore the film would require a significant time and temperature in order to seal by means of heat sealing. These requirements can lead to damage of the film such as for example pin-holes at the point where the film is stretched into the mould, causing leakage, especially problematic in the case of pouches containing liquid. Therefore, it is preferred that compartments made of films substantially insoluble in cold water and soluble in warm water and which house liquids are sealed using solvent which partially hydrates the film prior to sealing, lowering the time and temperature required for sealing, generating strong seals and avoiding pin-hole formation. In the preferred embodiment of differential solubility pouches having one compartment comprising a liquid composition and another compartment comprising a powder composition wherein the liquid compartment is made of material substantially insoluble in cold water and soluble in warm water and the powder compartment is made of material which is soluble in cold water, it is preferred that the liquid compartment be sealed by solvent-sealing while the liquid compartment is sealed to the powder compartment by heat sealing.

The pouch can also be placed outside the dispenser of a dishwasher or washing machine. In this case, it is preferred to make the entire pouch of a film material, as for example the one described herein above, which protects the pouch content until at least the start of the main-wash cycle.

Although the nature of the pouched products is such that it readily dissolves or disperses into the water, it may be preferred that disintegrating agents such as effervescence sources, water-swellable polymers or clays are present in the pouch itself, and/or in the product therein, in particular effervescence sources based on an acid and a carbonate source. Suitable acids include the organic carboxylic acids such as fumaric acid, maleic acid, malic acid, citric acid; suitable carbonate sources include sodium salts of carbonate, bicarbonate, percarbonate. Preferred levels for the disintegrating aids or effervescence sources or both are from 0.05% to 15% or even from 0.2% to 10% or even form 0.3 to 5% by weight of total pouched composition.

Any traditional cleaning ingredients can be used as part of the compositions of the multi-compartment pouch of the invention. The levels given are weight per cent and refer to the total composition of the pouch. The detergent compositions, will generally be built and comprise one or more detergent active components which may be selected from bleach, bleach activator, bleach catalyst, surfactants, alkalinity sources, enzymes, anti-corrosion agents (e.g. sodium silicate) and care agents. Highly preferred detergent components include a builder compound, an alkalinity source, a surfactant, an enzyme and an additional bleaching agent.

### EXAMPLES

A multi-compartment pouch having a powder compartment and two side-by-side liquid compartments superposed onto the powder compartment is made according to the process of the invention. The first forming unit has a horizontal moving forming surface comprising single cavity moulds, the second forming unit has a circular rotating forming surface comprising dual-cavities moulds.

The pouches are made as follows: a first polyvinyl alcohol (PVA) film gets laid down on the first forming surface and drawn into the moulds by vacuum to form recesses which are subsequently filled with a detergent powder composition and the powder is tamped, a web of open pouches (first web) is thereby formed. Simultaneously, a second PVA film gets laid down on the second forming surface and drawn into the dual-cavity moulds. Two different liquids are dosed into the two different cavities, at the top of the circular forming surface. The webs are held onto the forming surfaces by means of vacuum. A third PVA film (middle film) is wetted on a side placed on top of the liquid open pouches and sealed to form a web of close liquid pouches (second web). Water is applied on the outer side of the middle film. When the pouches of the second web reach the lowest point of the circular surface they are brought into contact with the first web and sealed due to pressure exerted by the first and second surfaces. The resulting web of multi-compartment pouches is cut to give rise to individual multi-compartments pouches.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for making a detergent water-soluble pouch having a plurality of compartments the process comprising the steps of:
a) making a first web of open or closed pouches in a first pouch making unit having a forming surface;
b) making a second web of open or closed pouches in a second pouch making unit having a forming surface;
c) combining the first and second webs of pouches wherein the forming surfaces bring the web of pouches into contact and preferably exert pressure on them to seal the webs; and
d) cutting the resulting web of pouches to produce individual pouches having a plurality of compartments.

2. A process according to claim 1 wherein one of the forming surfaces, preferably the forming surface of the second pouch making unit is coated with an elastic material.

3. A process according to claim 1 wherein the web of pouches are held onto the making surfaces by means of vacuum, preferably the vacuum applied to the first and second webs is maintained until after the two webs are combined.

4. A process according to claim 1 wherein the forming surface of the first pouch making unit is a horizontal unit and the forming surface of the second pouch making unit is preferably circular.

5. A process according to claim 1 wherein the second pouch making unit is placed above the first pouch making unit.

6. A process according to claim 1 wherein at least the second pouch making unit is a rotatory drum.

7. A process according to claim 1 wherein the two pouch making units are rotatory drums.

8. A process according to claim 1 wherein the first web of pouches formed in step a) is an open web.

9. A process according to claim 1 wherein the pouches formed in the second web are dual-compartment pouches preferably having a side-by-side configuration.

10. A process according to claim 1 wherein the water-soluble pouch has superposed compartments and side-by-side compartments and wherein the first web of pouches formed in step a) is an open web containing a composition in powder form and the pouches formed in the second web are dual-compartment pouches containing compositions in liquid form and having a side-by-side configuration.

11. A detergent water-soluble pouch obtainable according to or formed by the process of claim 1.

12. A detergent water-soluble pouch having a plurality of compartments wherein at least two compartments, preferably containing a liquid composition, are in a side-by-side configuration and these compartments are superposed onto another compartment, preferably containing a powder composition.

13. A method of laundry or dishwashing in an automatic machine using a pouch according to claim 12 comprising the step of placing the pouch in the interior of the machine in the presence of a soiled load.
